(19) United States
(12) Patent Application Publication
(10) Pub. No.: US 2026/0221052 A1
(43) Pub. Date: Jul. 30, 2026

(54) SECURE ACCESS CONTROL READER COMPRISING A SYSTEM FOR ENTERING A CODE WITH ACTIVATION OF A MODE SUITABLE FOR VISUALLY IMPAIRED PERSONS

(71) Applicant: SYSTEMES ET TECHNOLOGIES IDENTIFICATION (STID), Greasque (FR)

(72) Inventors: Vincent DUPART, Saint-Maximin-La-Sainte-Beaume (FR); Sylvain POITRAT, Greasque (FR); Jérôme SILVE, Rousset (FR); Cédric BERENGER, Pourrieres (FR)

(73) Assignee: SYSTEMES ET TECHNOLOGIES IDENTIFICATION (STID), Greasque (FR)

(21) Appl. No.: 19/145,771

(22) PCT Filed: Jan. 2, 2024
(86) PCT No.: PCT/FR2024/050003

§ 371 Date: Jul. 3, 2025

(30) Foreign Application Priority Data
Jan. 5, 2023 (FR) FR23/00134

(51) Int. Cl. G09B 21/00; G06F 3/01

(52) U.S. Cl. CPC G09B 21/007; G06F 3/016

(57) ABSTRACT

A secure access control reader integrating a code entry system includes: a tactile keyboard provided with discrete tactile keys assigned to characters, with one key provided with a locating relief, and configured to generate key signals following tactile contact exerted by a finger on the tactile keys; a processing unit configured to analyze the key signals to select characters, and operating in a mode suitable for sighted people and in a mode suitable for visually impaired people; and a lateral approach sensor distinct from the tactile keys, configured to detect an approach action performed by a user and, in response, deliver an approach signal, and the processing unit is connected to the lateral approach sensor and is configured to switch from the primary mode to the secondary mode upon receipt of the approach signal.

### TECHNICAL FIELD

The invention relates to a secure access control reader comprising an entry system for entering a code on a tactile keyboard.

It relates more particularly to an entry system for entering a code intended for visually impaired or blind people.

The invention therefore finds application in a secure access control reader requiring the entry of a code to authorize access to a secure space.

### PRIOR ART

As is known in the field of secure access control readers, appliances requiring the entry of a code comprising a sequence of characters, and in particular numbers, have a keyboard comprising several keys assigned to respective characters including numbers, and possibly also alphabetic characters and/or special characters, such as the characters «*» and «#», and/or functional characters, such as for example a validation key for validating the code once entered, or a backspace or correction key when entering the code, or even a key for canceling the complete entry.

Each key has a visual representation of a symbol informing the user about the character assigned to the key: indication of the number to which a numerical key relates for entering the numerical code; indication of the alphabetic character; indication of the special character; indication of the functional character (or function of the key), for example by a color, such as a green key for validating the code; a red key for canceling the entry; etc.

Conventionally, such a keyboard can be a mechanical keyboard or a tactile keyboard. The technologies differ between the two keyboard models, but the principle remains the same: namely that the keyboard comprises a plurality of discrete keys, and the user presses the keys to enter the associated characters.

In a mechanical keyboard, the keys are mechanical keys that the user must push or press to trigger the entry; in a tactile keyboard, the keys are formed by tactile sensors based on a touch (or contact) detection technology, such as for example capacitive, inductive, or infrared technology, so that the user only needs to touch the key to trigger the entry, without needing to perform any particular pressure. In practice, the keys of a tactile keyboard are domed, recessed, or embossed to make it possible to distinguish the keys.

However, the visual representations of the keys are difficult to access for people with visual impairments and are completely inaccessible to blind people.

Solutions have been designed in order to make keyboards accessible to visually impaired people.

In accordance with European standard EN 13332-3 06-1999, the «5» key on mechanical and tactile keyboards is provided with a tactile locating relief so that by moving their finger over the keyboard, the visually impaired person can identify this key and use it as a reference point to locate the other keys; the «2» key is located above the «5» key, the «4» key on the left, the «6» key on the right, etc. Similarly, for electronic payment terminals, embossings in the shape of an «O» and an «X» respectively are used so that the visually impaired person can locate the validation and cancel keys.

In the case of a mechanical keyboard, this solution with a tactile locating relief is sufficient, as the visually impaired person can search for and touch the mechanical keys to identify the tactile locating relief, without pressing them, so that there is no risk of triggering an erroneous entry of a character during this preliminary phase of searching for the locating relief.

However, this solution with a tactile locating relief is not satisfactory in the context of a tactile keyboard, as the visually impaired person must search for and touch the tactile keys to identify the tactile locating relief (generally by dragging his/her finger), then to search for the other keys once the tactile locating relief has been identified, so that he/she will inevitably trigger erroneous character entries during this preliminary phase of searching for the tactile locating relief and when searching for the keys (as the simple contact on a tactile key of a tactile keyboard triggers the entry of the concerned character, with no need to press the key as in a mechanical keyboard). Consequently, this preliminary phase on a tactile keyboard leads to the input of an erroneous code, thus making this solution less ergonomic for visually impaired people.

The state of the art can also be illustrated by solutions proposed in the field of automated teller machines for entering a bank code, usable as much by sighted people as by visually impaired or blind people.

Document U.S. Pat. No. 7,737,955 discloses an automated teller machine (ATM) equipped, for visually impaired and blind people, with a jack socket for plugging in headphones. Once plugged in, the user hears voice prompts through his/her headphones to guide and assist him/her in using the ATM. This solution is not very accessible for visually impaired and blind people as they ultimately have to use the ATM like a sighted person, but also not very practical because they have to carry their own headphones.

Documents EP2390606 and US2020/402423 disclose electronic payment terminal (EPT) solutions, each comprising at least one touch screen displaying a virtual keyboard and proposing, for entering the PIN code of a bank card, an entry mode intended for sighted people (sighted mode or primary mode) and an entry mode intended for visually impaired or blind people (visually impaired mode or secondary mode).

In EP2390606, the secondary mode is designed such that the validation of a key (corresponding, for example, to a number) is based on the time taken to press it exceeding a given time delay. By default, the EPT is in primary mode. The switch from primary mode to secondary mode is triggered either manually following a specific action on the EPT by a third party (such as, for example, the merchant), such as entering a switch code; or following a reading by the EPT of an information contained in the payment card relating to the visually impaired or blind status of the person holding the payment card.

Although satisfactory in the field of an electronic payment terminal, the switching solutions proposed in EP2390606 for switching from sighted mode to visually impaired mode have drawbacks. The solution requiring specific action by a third party necessarily requires the presence of such a third party, who must be informed and trained to act on the EPT in order to switch it to visually impaired mode when the opportunity arises; a solution that is also completely unsuitable for an access control reader where the user must be alone in front of the reader. The solution requiring the reading of an information contained in the payment card is only suitable for an EPT, due to the need to use such a payment card.

In US2020/402423, the switching from the primary mode, activated by default, to the secondary mode is triggered by a double-tap on the surface of the touch screen. This solution also has drawbacks because, although a time delay is defined to distinguish the double-tap from two consecutive presses, it is a source of errors because a sighted person could quickly type their code to the point that the terminal interprets it as a double-tap that switches it to the visually impaired mode, or conversely, a visually impaired person (such as an elderly person suffering from motor disorders) could make two successive presses, thinking they are performing a double-tap, which would not switch the terminal to the visually impaired mode.

### SUMMARY OF THE INVENTION

The invention aims to address the problem posed with a solution for entering a code on a tactile keyboard that is more accessible and ergonomic for visually impaired people. The solution can also be used by a sighted person.

Thus, the invention relates to a secure access control reader comprising an entry system for entering a code comprising a sequence of characters, this entry system comprising:
a tactile keyboard provided with discrete tactile keys assigned to respective characters including at least numbers, each tactile key comprising a tactile detection surface and the tactile detection surface of at least one of the tactile keys is provided with a locating relief, said tactile keyboard being configured to generate key signals in response to tactile contacts exerted by a finger on the tactile detection surfaces of the tactile keys, each of the key signals being associated with the tactile key on which the tactile contact is exerted; and
a processing unit connected to the tactile keyboard to acquire the key signals generated by the tactile keyboard, and configured to analyze said key signals to select characters according to said key signals;

wherein the processing unit is configured to operate in two distinct modes which are:
a primary mode, suitable for sighted people, in which the processing unit is configured to select each of the characters by operating as follows: acquisition of a key signal followed by automatic assignment of the character which is assigned to the tactile key associated with said key signal, so that a character is automatically selected by a tactile contact of a finger on the tactile key assigned to said character; and
a secondary mode suitable for the visually impaired and in which the processing unit is configured to select each of the characters as follows: acquisition of a key signal followed by a verification of an additional validation condition by analysis of the key signals, and allocation of the character which is assigned to the tactile key associated with said key signal only if the additional validation condition is met, such that a character is selected by tactile contact of a finger on the tactile key assigned to said character followed by compliance with the associated additional validation condition.

According to the invention, the secure access control reader comprises at least one lateral approach sensor configured to detect an approach action performed by a user in the form of an approach or contact of a hand of the user on at least one side of the tactile keyboard, and in response to deliver an approach signal, said at least one lateral approach sensor being distinct from the tactile keys of the tactile keyboard, and the processing unit is connected to the at least one lateral approach sensor and is configured to switch from the primary mode to the secondary mode upon receipt of the approach signal from the at least one lateral approach sensor.

In other words, the secure access control reader is based on the principle of allowing a visually impaired person to switch to the secondary mode that is more suitable for him/her, instead of the primary mode that uses sight, in an easy manner, by carrying out a predefined approach action, such as for example by approaching the tactile keyboard with his/her hand or a badge or by coming into contact with the tactile keyboard; this approach or this contact of the hand or badge being detected by the lateral approach sensor (or one of the lateral approach sensors). To the extent that the lateral approach sensor is distinct from the tactile keys of the tactile keyboard, a user cannot switch to the secondary mode by pressing one of the tactile keys; in other words, the processing unit is not configured to switch to the secondary mode upon receipt of a key signal, and it switches to the secondary mode only upon receipt of an approach signal that is different from the key signals.

It should be noted, for the purposes of this description, that the selection of a character by the processing unit means that the processing unit transmits this character as an input for the validation of the code. Each character selected by the processing unit forms a sequence of characters that is compared to the registered code, for example to authorize access, validate a payment, etc. This comparison of the sequence of characters selected by the processing unit can be performed within the processing unit, or within a host system that receives the selected characters from the processing unit and then compares them with the registered code.

This character selection process varies depending on whether the processing unit is in the primary or secondary mode. In the primary mode, each time a tactile key is touched, this results in the selection of the allocated character; while in the secondary mode, it is not sufficient to touch a tactile key to select the allocated character; an additional validation condition associated with this tactile key must also be met.

In use, a visually impaired person performs the approach action necessary to switch to the secondary mode without having to touch the tactile keys, since the lateral approach sensor is distinct from the tactile keys. The approach action takes the form of an approach or a contact of a hand on one side of the tactile keyboard, to the right, to the left, above, or below the front face of the tactile keyboard where the tactile keys are located.

In other words, the secure access control reader entry system is based on the principle of allowing a visually impaired person to switch to the secondary mode by approaching the tactile keyboard with his/her hand from the side or by coming into contact with one side of the tactile keyboard; this approach or this contact of the hand is detected by the lateral approach sensor (or one of the lateral approach sensors).

Since the lateral approach sensor is distinct from the tactile keys (in other words, distinct from the means implemented by the tactile keyboard to enter characters), a conventional approach of the hand by a sighted person on the tactile keyboard (in other words, on the front face where the tactile keys are arranged) will not be detected by this lateral approach sensor and will therefore not be confused with an approach on the side used to switch to the secondary mode. On the other hand, when a visually impaired person approaches the keyboard with his/her hand, he/she naturally searches for the keyboard using a swiping gesture, which leads to an approach or a contact on one side of the keyboard, and therefore to detection by the lateral approach sensor.

It should be noted that the side of the tactile keyboard means, for the purposes of the present description, a lateral portion extending next to the front face of the tactile keyboard; in other words, this front face of the tactile keyboard is clearly excluded from the definition of the side of the tactile keyboard. Moreover, when the tactile keyboard is embedded in a locker and/or is integrated into a secure access control reader, then the side of the tactile keyboard can correspond to the side of the locker and/or the side of this reader.

Such an approach action has the advantage of being simple and practical to perform.

After activating the secondary entry mode, the visually impaired or blind person then touches the keys to search for the locating relief and then touches the tactile keys by dragging his/her finger across the touch panel in order to enter the code, while respecting the additional validation conditions. Indeed, when the processing unit is in the secondary mode, this mode is well suited to visually impaired people as an accidental contact on a tactile key does not automatically trigger the selection of the allocated character; but an additional action is still required to meet the additional validation condition. Thus, this secondary mode is provided to avoid unwanted character selections when the visually impaired person gropes on the screen keys, in particular when searching for the locating relief or a key.

A sighted person, on the other hand, carries out a tactile entry directly, by pressing the tactile keys that he/she sees, because the tactile keyboard operates in the primary mode suitable for sighted persons, that is to say with conventional entry by simple tactile contacts on the tactile keys, in other words, each tactile contact on a tactile key automatically triggers the selection of the allocated character.

It should be noted that, according to the invention, the keyboard is a tactile keyboard, with tactile keys that are discrete keys each allocated to a specific character; It being conceivable that the characters may comprise numbers only, namely the numbers «0» to «9», or comprise both these numbers and other characters, such as alphabetic characters and/or special characters, such as, for example, the characters «*» and «#», and/or functional characters, such as, for example, «validation», «correction or backspace», «cancel». For the purposes of the invention, this tactile keyboard is not a mechanical keyboard with mechanical keys that must be pressed or pushed.

According to one possibility, the processing unit is configured to be by default in the primary mode, in the absence of reception of the approach signal from the at least one lateral approach sensor.

According to another possibility, the processing unit, when in secondary mode, is configured to automatically switch from the secondary mode to the primary mode once the entry of the characters forming the code has been completed, for example after a predefined time delay.

In other words, when the visually impaired person has correctly entered the code in the secondary mode, then the processing unit automatically returns to the primary mode.

According to one feature, the processing unit, when in secondary mode, is configured to automatically switch from the secondary mode to the primary mode if no key signal is generated by the tactile keyboard after a predefined period of time.

Thus, if the secondary mode is activated and no tactile key is touched during this period of time, then the processing unit automatically returns to the primary mode.

In a particular embodiment, the at least one lateral approach sensor comprises at least one side sensor that is positioned on at least one side of the tactile keyboard. By placing this side sensor on one side of the tactile keyboard, it is easy to detect a hand approaching that side (or coming into contact with that side), as long as that hand approaches that side sensor.

As previously explained, this side sensor can be arranged directly on the side of the tactile keyboard, and can also be arranged on the side of the locker and/or the reader.

According to one possibility, the at least one side sensor is selected from a capacitive sensor, an inductive sensor, a radar sensor, an ultrasonic sensor, an accelerometer, a camera, and a mechanical sensor.

Such capacitive, inductive, radar, ultrasonic, or optical (in the form of a camera) sensors are advantageous for reliably detecting the approach of the hand to the side of the tactile keyboard; an accelerometer is advantageous for detecting a contact (in the form of a shock) of the hand to the side of the tactile keyboard; a mechanical sensor (switch type) is also advantageous for detecting a contact (in the form of a force on the mechanical sensor) of the hand to the side of the tactile keyboard.

In an advantageous embodiment, the at least one side sensor comprises several side sensors arranged on several sides of the tactile keyboard, or a peripheral sensor extending over several sides of the tactile keyboard.

Thus, the hand can approach the tactile keyboard from several sides, or even any side, to activate the secondary mode.

In another embodiment, the at least one lateral approach sensor comprises at least one facade sensor which is positioned on a front face of the tactile keyboard on which the tactile keys are arranged, such a facade sensor having a detection field making it possible to detect the approach or contact of the user's hand on at least one side of the tactile keyboard.

Thus, in this variant, the lateral approach sensor is not positioned on the side of the tactile keyboard (as is the case with the side sensor), but is positioned on the front face of the tactile keyboard, while still being able to detect the approach or contact of the user's hand on the side of the tactile keyboard thanks to a wide detection field.

According to another possibility, the at least one facade sensor is selected from a radar sensor, an ultrasonic sensor, and a camera.

Thus, the facade sensor can be a wide-angle camera able to see to the sides while being arranged on the front face of the tactile keyboard, and for example, in the center of the keyboard.

According to one possibility, the processing unit is configured to switch from the primary mode to the secondary mode upon receipt of two consecutive approach signals from the at least one lateral approach sensor, the two consecutive approach signals being spaced apart by a time interval less than a given threshold.

This option is advantageous as it ensures that a simple approach of the hand on the side cannot activate the secondary mode; only a double approach or double contact, sometimes called a «tap-tap», will allow switching to the secondary mode.

Moreover, the processing unit is configured to remain in primary mode if the time interval is greater than the given threshold.

In a first embodiment, the processing unit is configured such that, in the secondary mode, following the acquisition of a key signal, called the first key signal, associated with a tactile key assigned to a character, the additional validation condition comprises the acquisition of a second key signal associated with the same tactile key after a period without acquisition of a key signal between the acquisitions of the first key signal and the second key signal, such that a character is selected by a first tactile contact of a finger on the tactile key assigned to said character, followed by a removal of said finger, then followed by a second tactile contact of the finger on the same tactile key assigned to said character.

In other words, the access control reader relies, when operating in this first embodiment of the secondary mode, on an acquisition of two successive tactile contacts on the same tactile key to select the character assigned to the tactile key; thus, an accidental tactile contact on a tactile key (for example, when the finger drags over it), not followed by a removal of the finger and then a new tactile contact on this same key, will not lead to the selection of the character assigned to the key.

Thus, thanks to this first implementation of the secondary mode, the visually impaired person simply drags his/her finger on the tactile keyboard to detect the locating relief (by dragging, the finger passes over tactile keys but no character selection occurs), then drags his/her finger from the locating relief to reach the target tactile key (and thus the processing unit acquires a first key signal associated with this target tactile key), lifts his/her finger (and thus the processing unit no longer detects a key signal, and therefore detects the removal of the finger), and finally places his/her finger back on the target tactile key (and thus the processing unit acquires a second key signal associated with this target tactile key), so that the processing unit selects the character assigned to this target tactile key. The operation is repeated by dragging the finger to the new target tactile key, then lifting the finger and placing the finger again on the new target tactile key. In other words, a character is selected by a double touch on the same key; the first touch may be at the end of a finger drag after entering a previous character, and the second touch may be the beginning of a finger drag to enter a next character.

Advantageously, the processing unit is configured so that, in the secondary mode, the additional validation condition also comprises a comparison between a maximum time threshold and the period between the acquisitions of the first key signal and the second key signal, such that a character is selected by the first tactile contact of the finger on the tactile key assigned to said character, followed by a removal of said finger, then followed by the second tactile contact of the finger on the same tactile key assigned to said character, within a time less than the maximum time threshold between the first tactile contact and the second tactile contact.

In other words, for two successive contacts on the same tactile key to be taken into account to select the character assigned to the tactile key, the delay (also called period) between the two contacts must be less than this maximum time threshold; in other words, the two contacts must be close together in time. This maximum time threshold can, for example, be in the range of 1 to 2 seconds, and it can be configurable.

In a second embodiment, the processing unit is configured such that, in the secondary mode, the additional validation condition comprises a minimum contact duration for the key signal, such that a character is selected by a tactile contact of a finger on the tactile key assigned to said character on the condition that this tactile contact lasts at least the minimum contact duration.

In other words, the secure access control reader relies, when operating in this second embodiment of the secondary mode, on the acquisition of a long contact (that is to say of a duration greater than the minimum contact duration) on the same tactile key to select the character assigned to the tactile key; thus, an unfortunate tactile contact (when the finger drags over the key because the person is looking for the locating relief or a specific key) and therefore short (of a duration less than the minimum contact duration) on a tactile key will not lead to the selection of the character assigned to the key. This minimum contact duration may, for example, be in the range of 2 to 3 seconds.

Advantageously, the processing unit is connected to at least one audible or vibratory alert transmitter, and the processing unit is configured to drive the at least one alert transmitter in order to produce an alert signal, which is audible or vibratory, when said processing unit switches from the primary mode to the secondary mode.

In this way, the visually impaired person is warned that the secondary mode is now activated.

According to one feature, the processing unit is connected to at least one audible or vibratory feedback transmitter, and the processing unit is configured to, at least in the secondary mode, drive the at least one feedback transmitter in order to produce an audible or vibratory feedback signal, when the processing unit selects a character.

Advantageously, the feedback (whether audible and/or vibratory) that the visually impaired user will hear or feel when his/her finger is placed on a tactile key of the tactile keyboard will warn him/her that he/she has selected a number. It is possible to provide such feedback also in the primary mode.

The invention also relates to an entry method for entering a code comprising a sequence of characters, this entry method operating on an entry system of a secure access control reader as previously described, and comprising:
generating key signals in response to tactile contacts exerted by a finger on the tactile detection surfaces of the tactile keys, each of the key signals being associated with the tactile key on which the tactile contact is exerted;
acquiring by the processing unit the key signals generated by the tactile keyboard;
analyzing by the processing unit said key signals to select characters according to said key signals.

This entry method comprises a primary mode, suitable for sighted persons, and a secondary mode, suitable for visually impaired persons.

In the primary mode, the processing unit carries out the following steps to select each of the characters: acquisition of a key signal followed by automatic assignment of the character assigned to the tactile key associated with said key signal, such that a character is automatically selected by a tactile contact of a finger on the tactile key assigned to said character.

In the secondary mode, the processing unit carries out the following steps to select each of the characters: acquisition of a key signal followed by a verification of an additional validation condition by analyzing the key signals, and assignment of the character assigned to the tactile key associated with said key signal only if the additional validation condition is met, such that a character is selected by a tactile contact of a finger on the tactile key assigned to said character followed by compliance with the associated additional validation condition.

This entry method comprises a step of switching from the primary mode to the secondary mode upon receipt of at least one approach signal from the at least one lateral approach sensor shaped to detect an approach action performed by a user in the form of an approach or contact of the user's hand on at least one side of the tactile keyboard, said at least one lateral approach sensor being distinct from the tactile keys of the tactile keyboard.

Of course, all the features previously mentioned for the entry system are also applied to the entry method.

### BRIEF DESCRIPTION OF THE FIGURES

Other features and advantages of the present invention will become apparent upon reading the detailed description below, of a non-limiting example of implementation, made with reference to the appended figures in which:

FIG. 1 is a schematic view of an entry system comprised in a secure access control reader and provided with a tactile keyboard, a processing unit which is in the primary mode suitable for sighted people, and a lateral approach sensor which is here a side sensor;

FIG. 2 is a schematic view equivalent to that of FIG. 1, showing a simple tactile contact on the tactile key «2» allowing the selection of the number «2» in the primary mode by the processing unit;

FIG. 3 is a schematic view of the entry system of FIG. 1, illustrating a detection by the side sensor of an approach action of a user, in the form of an approach or a contact of a hand on one side of the tactile keyboard, such that the processing unit switches to the secondary mode suitable for the visually impaired people;

FIG. 4 is a schematic view equivalent to that of FIG. 3, illustrating in the secondary mode the start of a tactile search phase for the locating relief by a visually impaired person, who puts his/her finger on a starting location which is here the tactile key «7» without the number «7» being selected in the secondary mode;

FIG. 5 is a schematic view equivalent to that of FIG. 4, where the dragging of the visually impaired person's finger from the starting location until reaching the locating relief placed here on the tactile key «5» is illustrated in the secondary mode, without the number «5» being selected in the secondary mode;

FIG. 6 is a schematic view equivalent to that of FIG. 5, where the dragging of the visually impaired person's finger from the locating relief until reaching a target tactile key, which is here the tactile key «3», is illustrated in the secondary mode, without the number «3» being selected in the secondary mode;

FIG. 7 is a schematic view equivalent to that of FIG. 6, where the removal of the finger (in other words the detachment of the finger) from the target tactile key, here the tactile key «3», is illustrated in the secondary mode, in order to achieve the additional validation condition to be able to select the number «3» in the secondary mode;

FIG. 8 is a schematic view equivalent to that of FIG. 7, where the return of the finger to contact with the target tactile key, here the tactile key «3», is illustrated in the secondary mode, in order to finalize the additional validation condition allowing the selection of the number «3» in the secondary mode by the processing unit;

FIG. 9 is a schematic view of a variant of the entry system of FIG. 1 which is not covered by the claims, and for which the entry system comprises a radio identification sensor, and where a detection by the radio identification sensor of an approach action of a user, in the form of an approach of a radio identification badge, is illustrated, such that the processing unit switches to the secondary mode suitable for the visually impaired people;

FIG. 10 is a schematic view of another variant of the entry system of FIG. 1, comprising a camera-type facade sensor in place of the side sensor to form the lateral approach sensor;

FIG. 11 is a schematic view of a secure access control reader incorporating the entry system, with a user in a situation of entering a code.

### DETAILED DESCRIPTION OF ONE OR SEVERAL EMBODIMENTS OF THE INVENTION

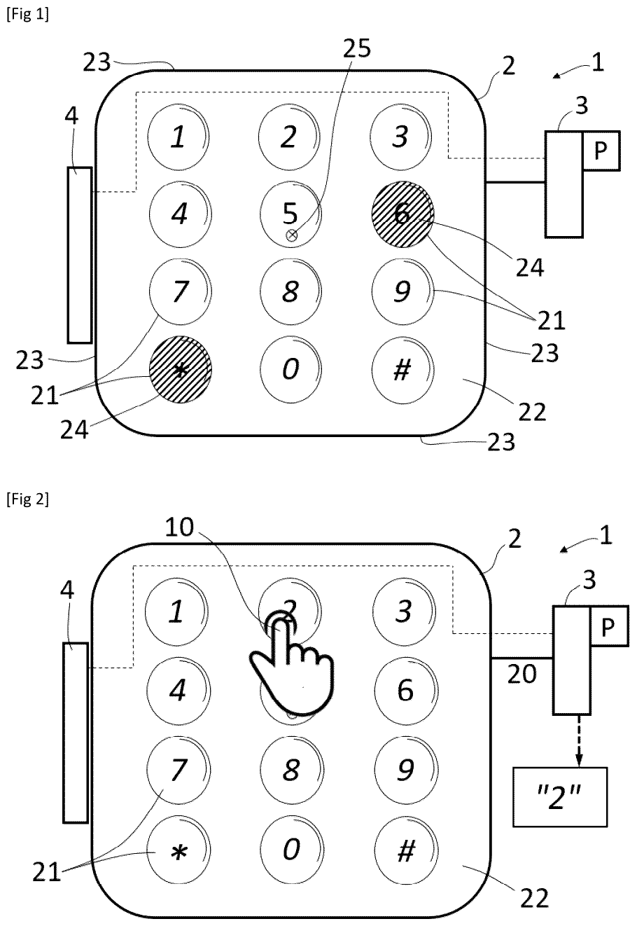

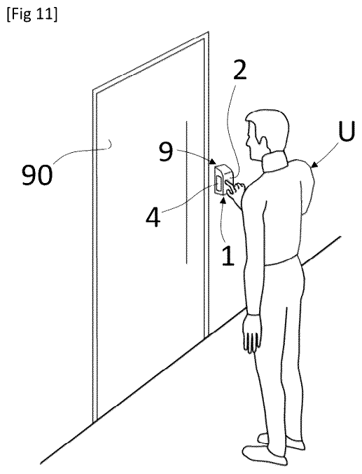

With reference to FIGS. 1 to 11, an entry system 1 comprises a tactile keyboard 2 provided with discrete tactile keys 21 assigned to respective characters, including at least numbers. In the illustrated example, the tactile keys 21 are twelve in number and comprise ten tactile keys assigned to the numbers «0» to «9», and two tactile keys assigned to the special characters «#» and «*». Of course, other characters are possible. In the remainder of the description, a tactile key 21 assigned to a character «X» (for example, the number «5») will be called the tactile key «X» (for example, tactile key «5»). The entry system 1 is integrated into a secure access control reader 9 for entering an access code authorizing access to a secure area, for example, to open a door 90 or an access barrier.

These tactile keys 21 are arranged on a front face 22 (also called front facade) of the tactile keyboard 2. The tactile keyboard 2 also has sides 23 (or lateral edges) which border the front face 22 on the periphery. In the illustrated example, the tactile keyboard 2 has a generally square or rectangular shape, so that it has four sides 23, which are a right side, a left side, a top side, and a bottom side.

These tactile keys 21 may be domed in shape, for example recessed in the form of a crater or embossed in the form of a dome, in order to be identifiable by touch.

Each tactile key 21 comprising a tactile detection surface 24, shown schematically by hatching on the tactile keys «6» and «#» in FIG. 1. The tactile detection surface 24 of at least one of the tactile keys 21 is provided with a locating relief 25; in the illustrated example, only the tactile key «5» is provided with such a locating relief 25, this tactile key «5» being substantially in the center of the tactile keys 21, as can be seen in a standard keyboard.

The tactile keyboard 2 is configured to generate key signals 20 in response to tactile contacts exerted by a finger 10 on the tactile detection surfaces 24 of the tactile keys 21, each of the key signals 20 being associated with the tactile key 21 on which the tactile contact is exerted. This tactile contact is sometimes called pressing, however it is sufficient to touch the tactile detection surface 24 to generate the associated key signal 20, without necessarily exerting pressure on the tactile detection surface 24, for example by dragging one's finger 10 over it. Thus, a tactile contact on the tactile detection surface 24 of the tactile key «0» generates the key signal 20 associated with the character «0» (also called the «0» key signal), a tactile contact on the tactile detection surface 24 of the tactile key «1» generates the key signal 20 associated with the character «1» (also called the «1» key signal), a tactile contact on the tactile detection surface 24 of the tactile key «2» generates the key signal 20 associated with the character «2» (also called the «2» key signal), etc. and this for each tactile key 21.

The entry system 1 of the secure access control reader 9 further comprises a processing unit 3 which is connected to the tactile keyboard 2 to acquire the key signals 20 generated by the tactile keyboard 2, and configured to analyze these key signals 20 to select characters according to the key signals 20. This processing unit 3 can be a processor, a controller, an electronic board or a computer terminal.

The processing unit 3 is configured to operate in two distinct modes, which are a primary mode P suitable for sighted people and a secondary mode S suitable for visually impaired people; these two modes P, S differing in the way of processing/analyzing the key signals 20 to select the characters, and therefore in the way the user U acts on the tactile keys 21 to enter a character.

Thus, the entry system 1 makes it possible to enter a code comprising a sequence of characters, and the processing unit 3 is configured to select the characters by means of tactile contacts on the dedicated tactile keys 21.

In the primary mode P, the processing unit 3 is configured to select each of the characters by operating as follows: acquisition of a key signal 20 followed by automatic assignment of the character which is assigned to the tactile key 21 associated with said key signal 20. Thus, a character is automatically selected by a tactile contact of a finger 10 on the tactile key 21 assigned to said character. For the user, it is therefore sufficient to touch one of the tactile keys 21 with his/her finger 10 to select the character assigned to this tactile key 21.

In the example in FIG. 2, the user performs a tactile contact on the tactile key «2», and thus the tactile keyboard 2 generates the key signal 20 associated with the character «2» (or «2» key signal), and the processing unit 3 selects the number «2». If the user lifts the finger 10 and places the finger 10 back again on this same tactile key «2», the processing unit 3 will again select the number «2». If the user drags the finger 10 on the front face 22 and his/her finger 10 passes over the tactile key «2», the processing unit 3 will also select the number «2».

It is therefore obvious that this primary mode P is suitable for sighted people, as it is necessary to point at the tactile keys 21 to enter/select the characters; as any contact with a tactile key 21 triggers the entry of the associated character. In other words, this primary mode P is unsuitable for visually impaired people who must drag their finger 10 on the front face 22 to search by touch for the locating relief 25 and then the tactile keys 21; indeed this dragging of the finger 10 on the front face 22 would automatically trigger erroneous entries or selections of characters.

To switch to the secondary mode S, the entry system 1 comprises at least one lateral approach sensor, which is a side sensor 4 in the example of FIGS. 1 to 8 or a facade sensor 6 in the example of FIG. 10, in which this lateral approach sensor 4, 6 is distinct from the tactile keys 21 of the tactile keyboard 2 and is shaped to detect an approach action carried out by a user, and in response to output an approach signal 40, 60.

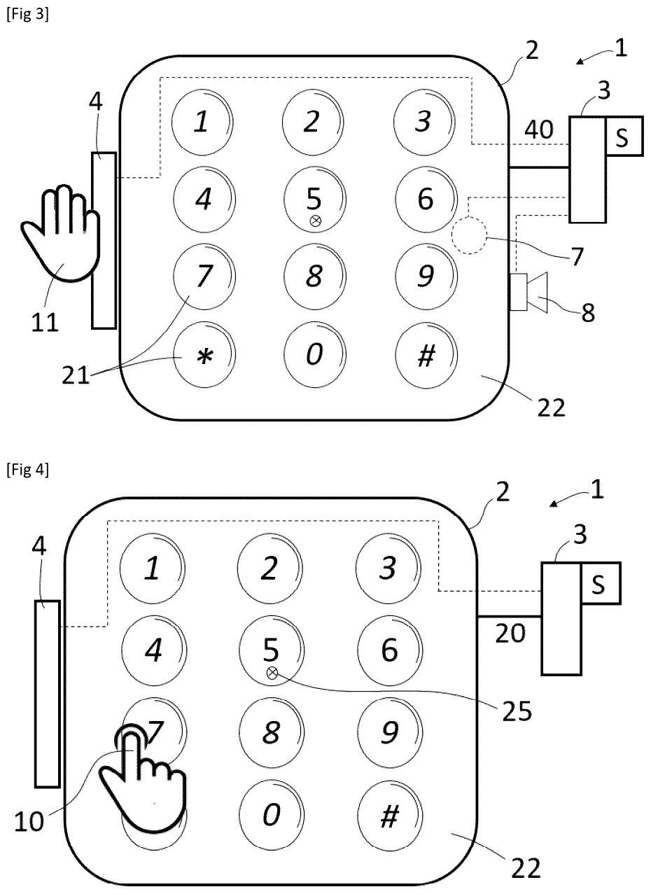

In the example of FIGS. 1 to 8, the lateral approach sensor is a side sensor 4 positioned on at least one side 23 of the tactile keyboard 2 to detect the approach action in the form of an approach or a contact of a user's hand 11 on this side 23 of the tactile keyboard 2, as illustrated in FIG. 3; this side sensor 4 forming for example a proximity sensor, or a presence or contact detection sensor. In this example, a side sensor 4 positioned on only one side 23 of the tactile keyboard 2, here the left side, is provided.

Alternatively, the entry system 1 may comprise several side sensors 4 positioned on several sides 23 of the tactile keyboard 2, or even on all sides 23 of the keyboard 2. Alternatively, the entry system 1 may comprise at least one side sensor 4 extending over several sides 23 of the tactile keyboard 2, in which case it is referred to as a peripheral sensor. In these variants, the approach action is in the form of an approach or a contact of a user's hand 11 on one of the several sides 23 of the tactile keyboard 2 equipped with a side sensor 4.

The or each side sensor 4 may be selected from a capacitive sensor, an inductive sensor, a radar sensor, an ultrasonic sensor, an optical sensor (or camera), an accelerometer, and a mechanical sensor.

In the example of FIG. 10, the approach sensor is a facade sensor 6 which is positioned on the front face 22 of the tactile keyboard 2 (on which the tactile keys 21 are arranged, as a reminder), in which this facade sensor 6 has a detection field making it possible to detect the approach or contact of the user's hand 11 on at least one side 23 of the tactile keyboard 2; this facade sensor 6 thus forming a lateral approach sensor like the side sensor described above. In the illustrated example, this facade sensor 6 is a camera 6, and in particular a wide-angle camera for viewing the sides of the tactile keyboard 2.

The processing unit 3 is connected to the lateral approach sensor 4, 6 and is configured to switch from the primary mode P to the secondary mode S upon receipt of the approach signal 40, 60 from the lateral approach sensor 4, 6.

The entry system 1 may also comprise at least one alert transmitter 7, 8 connected to the processing unit 3, such as for example a vibratory alert transmitter 7 and/or an audible alert transmitter 8 as illustrated in FIG. 3; so that the processing unit 3 is configured to drive this vibratory alert transmitter 7 and/or this audible alert transmitter 8 in order to produce an alert signal, which is audible or vibratory, when the processing unit 3 switches from the primary mode P to the secondary mode S.

The processing unit 3 is configured to be by default in the primary mode P, in the absence of reception of the approach signal 40, 60 from the lateral approach sensor 4, 6.

Moreover, when the processing unit 3 is in the secondary mode S, it is configured to automatically switch from the secondary mode S to the primary mode P once the entry of the characters forming the code has been completed, for example after a predefined time delay. In other words, when a visually impaired person has switched the processing unit to the secondary mode S and then correctly entered the code on the tactile keyboard 2, then the processing unit 3 automatically returns to the primary mode P.

Furthermore, when the processing unit 3 is in the secondary mode S, it is configured to automatically switch from the secondary mode S to the primary mode P if no key signal 20 is generated by the tactile keyboard 2 after a predefined period of time. In other words, when a visually impaired person has switched the processing unit to the secondary mode S and then has not touched any tactile key 21 or has stopped touching the tactile keys 21, then the processing unit 3 automatically returns to the primary mode P.

The processing unit 3 can be configured to drive the vibratory alert transmitter 7 and/or the audible alert transmitter 8 in order to produce an alert signal, which is audible or vibratory, when the processing unit 3 switches back from the secondary mode S to the primary mode P.

As previously explained, the secondary mode S differs from the primary mode P in the way of entering characters on the tactile keyboard 2. More precisely, in the secondary mode S, the processing unit 3 is configured to select each of the characters as follows: acquisition of a key signal 20 (called the first key signal) followed by a verification of an additional validation condition by analysis of the key signals 20 (namely the first key signal and possibly also a second key signal which follows the first key signal), and allocation of the character which is assigned to the tactile key associated with said first key signal only if the additional validation condition is met. Thus, a character is selected by a tactile contact of a finger 10 on the tactile key 21 assigned to said character followed by compliance with the associated additional validation condition. For the user, it is therefore necessary to touch one of the tactile keys 21 with his/her finger 10, and it is then necessary to meet the associated additional validation condition, in order to select the character assigned to this tactile key 21.

In the example illustrated in FIGS. 4 to 8, the processing unit 3 is configured so that, in the secondary mode S, following the acquisition of a key signal 20, called the first key signal, associated with a tactile key 21 assigned to a character, the additional validation condition comprises the acquisition of a second key signal 20 associated with the same tactile key 21 after a period without acquisition of a key signal between the acquisitions of the first key signal and the second key signal. Thus, a character is selected by a first tactile contact of a finger 10 on the tactile key 21 assigned to this character, followed by a removal of the finger 10 (which then no longer touches a tactile key 21), then followed by a second tactile contact of the finger 10 on the same tactile key 21 assigned to this character; this is then referred to as a so-called double-contact additional validation condition.

In other words, the visually impaired person simply needs to drag his/her finger 10 over the target tactile key 21 (the one associated with the character he/she wants to enter), which triggers the acquisition of the first key signal 20 associated with this target tactile key 21, then to lift the finger 10 and then place the finger 10 back on this same target tactile key 21, which triggers the acquisition of the second key signal 20 associated with this target tactile key 21; and then the processing unit 3 selects the character assigned to this target tactile key 21. The visually impaired person can then drag his/her finger 10 towards another target tactile key 21 and repeat the operation.

According to one possibility, the additional validation condition also comprises a comparison between a maximum time threshold and the period between the acquisitions of the first key signal 20 and the second key signal 20, so that a character is selected following the first tactile contact of the finger on the tactile key 21 assigned to said character, followed by a removal of said finger, and finally followed by the second tactile contact of the finger on the same tactile key 21 assigned to said character, within a time less than the maximum time threshold between the first tactile contact and the second tactile contact.

In other words, if the duration is too long (that is to say it exceeds the maximum time threshold) between the two successive tactile contacts on the same tactile key 21, then the processing unit 3 will not select the character assigned to this tactile key 21.

With reference to FIG. 4, at the start of the entry, the visually impaired person places his/her finger 10 at a starting location on the front face 22 of the tactile keyboard 2, with the aim of finding the locating relief 25 by dragging his/her finger 10 on the front face 22. In FIG. 4, the finger 10 is placed on the tactile key “7” which is therefore the starting location here. Thus, the processing unit 3 receives the «7» key signal.

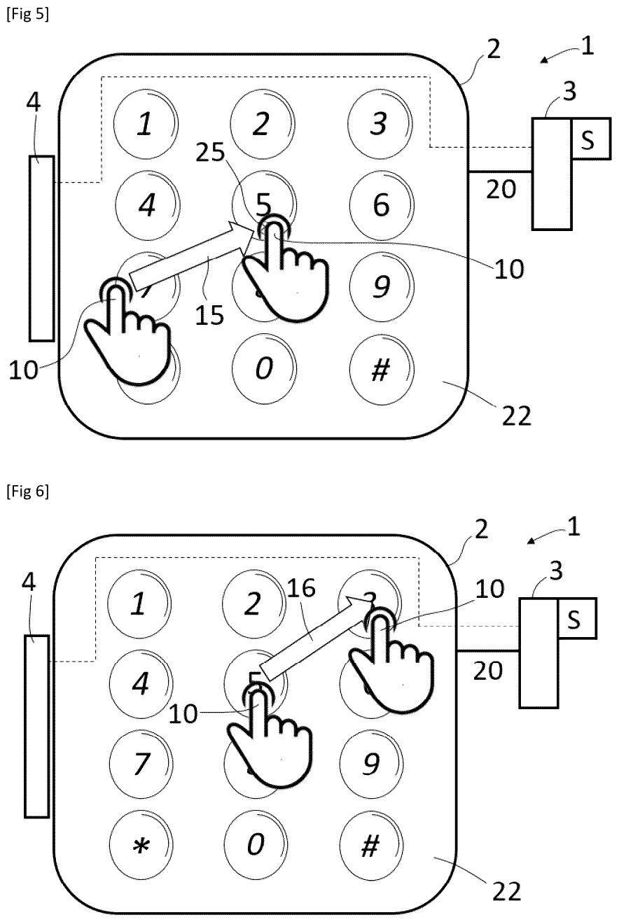

With reference to FIG. 5, the visually impaired person drags his/her finger 10 from the starting location until it reaches the locating relief 25; the dragging movement of the finger 10 being here shown schematically by the arrow 15. Also, in the example illustrated, finger 10 is dragged from the tactile key «7» to the locating relief 25 placed on tactile key «5». Thus, the processing unit 3 receives the «5» key signal.

It should be noted that, in the secondary mode S, the processing unit 3 does not select the number «7», even though it has acquired the «7» key signal at the start of the entry. Indeed, to the extent that the visually impaired person, after placing his/her finger 10 on the tactile key «7», has not performed an action of removing the finger 10 and then placing the finger 10 back on this same tactile key «7», then the additional validation condition has not been met and therefore the processing unit 3 does not select the number «7».

With reference to FIG. 6, once the visually impaired person has his/her finger 10 on the locating relief 25, he/she mentally visualizes the tactile key «5» under his/her finger 10 as well as the other tactile keys 21 of the tactile keyboard 2, and he/she can therefore go and find the tactile keys 21 by dragging his/her finger 10 to successively enter the characters forming the code. In the example illustrated, the first character to be entered is the number «3», also the visually impaired person drags his/her finger 10 from the locating relief 25 (or from the tactile key «5») to the target tactile key 21 which is here the tactile key «3»; the dragging movement of the finger 10 being here shown schematically by the arrow 16. Thus, the processing unit 3 receives the «3» key signal, called the first «3» key signal.

It should be noted that, in the secondary mode S, the processing unit 3 does not select the number «5», even though it has acquired the «5» key signal when the finger 10 came into contact with the locating relief 25 placed on the «5» tactile key. Indeed, to the extent that the visually impaired person, after dragging his/her finger 10 onto the tactile key «5», has not performed an action of removing the finger 10 and then placing the finger 10 back on this same tactile key «5» (indeed, the finger 10 has been dragged again to go to the tactile key «3», without detaching the finger 10), then the additional validation condition has not been met and therefore the processing unit 3 does not select the number «5».

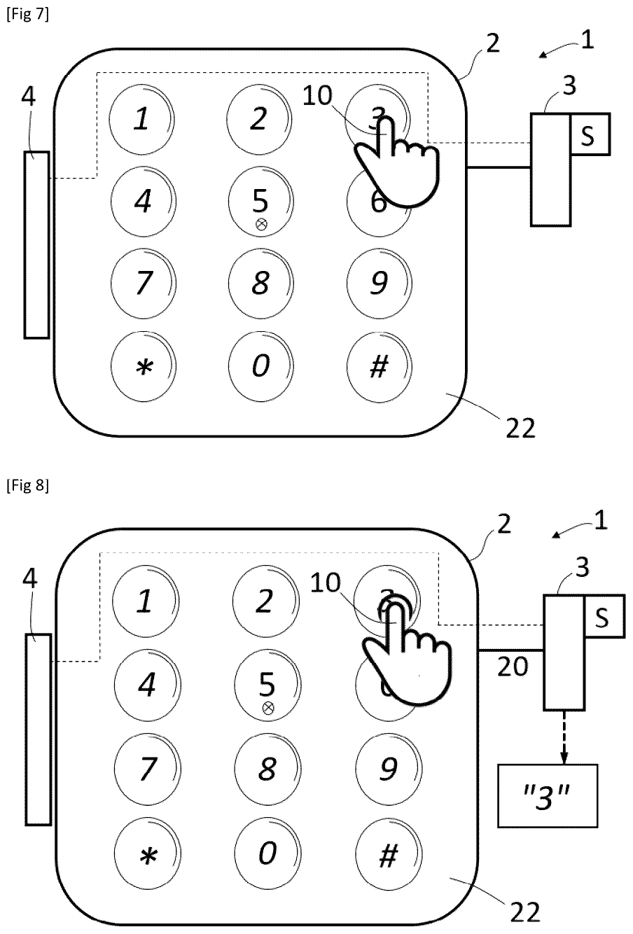

With reference to FIG. 7, once the visually impaired person has his/her finger 10 on the target tactile key 21, which is here the tactile key «3», he/she removes (or detaches) his/her finger 10.

With reference to FIG. 8, the visually impaired person, after having removed (or detached) his/her finger 10, places again his/her finger 10 back in contact with the target tactile key 21, which is here the tactile key «3», so that the tactile keyboard 2 generates a second «3» key signal. The processing unit 3 then receives this second «3» key signal, and deduces therefrom that the additional validation condition is met to perform a selection of the number «3»; also on condition that the finger 10 has been removed for a duration less than or equal to the maximum time threshold, or else on condition that the period (or duration) between the acquisition of the first «3» key signal and the second «3» key signal is less than or equal to the maximum time threshold.

A key signal 20, as previously presented, can be in the form of a point rising signal (in other words a pulse) generated by the tactile keyboard 2 as soon as a finger touches a tactile key 21, and transmitted to the processing unit 3 for analysis. This key signal 20 of course contains information identifying the tactile key 21 which is touched. Also, holding the finger 10 on a tactile key 21 and then removing it has no impact on the operation of the tactile keyboard 2 which only reacts to contacts and not to removals. Thus, for the tactile keyboard 2 to be able to generate a first key signal and then a second key signal for the same tactile key 21, it is necessary for the finger 10 to be removed (or detached) between two tactile contacts on this same tactile key 21.

If the visually impaired person then needs to enter a new character (here a character distinct from the number «3») associated with a new target tactile key 21, then the visually impaired person can repeat the operation by dragging his/her finger 10 towards this new target tactile key 21, either directly if his/her mental visualization of the tactile keyboard 2 allows him/her to do so, or by going back through the locating relief 25 and therefore through the tactile key «5».

In a first variant, if the visually impaired person has to enter the same character again (here the number «3»), then the visually impaired person can remove the finger 10, and then repeat the operation of placing the finger 10 on the tactile key «3», then removing finger 10 for a duration less than or equal to the maximum time threshold, and finally placing the finger 10 back on this same tactile key «3». In other words, in this first variant, to enter «33» (in other words to enter the character «3» twice in a row), a first double contact must be made to enter the first «3», then a second double contact must be made to enter the second «3». In other words, four tactile contacts must be made in a row, with a first and second tactile contact to enter the first «3», and then a third and fourth tactile contact to enter the second «3» (the third tactile contact and the fourth tactile contact being considered a first tactile contact and a second tactile contact for the second «3»).

In a second variant, if the visually impaired person has to enter the same character again (here the number «3»), then the visually impaired person can remove the finger 10, for a duration less than or equal to the maximum time threshold, and then puts again the finger 10 back on the same tactile key «3». In other words, in this second variant, to enter «33» (in other words, to enter the character «3» twice in a row), a triple contact must be made to enter the two «3»s in a row. In other words, three tactile contacts must be made in a row, with a first and a second tactile contact to enter the first «3», and then a third tactile contact to enter the second «3» (the second tactile contact and the third tactile contact being considered a first tactile contact and a second tactile contact for the second «3»).

In an alternative embodiment, the processing unit 3 is configured so that, in the secondary mode S, the additional validation condition comprises a minimum contact duration for the key signal 20. Thus, a character is selected by a tactile contact of a finger 10 on the tactile key 21 assigned to said character on the condition that this tactile contact lasts at least the minimum contact duration; this is then referred to as a so-called long contact additional validation condition.

In other words, a character is selected by a tactile contact of a finger 10 on the tactile key 21 assigned to this character, on the condition that this tactile contact is a long contact in the sense that it lasts longer than the minimum contact duration; on the other hand, if the visually impaired person makes a tactile contact on a tactile key 21 and this tactile contact is a short contact in the sense that it lasts less than the minimum contact duration, then the processing unit 3 does not select the character assigned to this tactile key 21.

In the situation, at the start of the entry, the visually impaired person places his/her finger 10 at a starting location on the front face 22 of the tactile keyboard 2, with the aim of finding the locating relief 25 by dragging his/her finger 10 on the front face 22. As long as the finger 10 drags on the front face 22, without remaining on a tactile key 21 for longer than the minimum contact duration, then the processing unit 3 does not select any character. The visually impaired person drags his/her finger 10 from the starting location until it reaches the locating relief 25 and therefore the tactile key «5».

Then, the visually impaired person can continue their dragging movement from the locating relief 25 (or from the tactile key «5») to the target tactile key 21, which is, for example, the tactile key «3» in the example previously presented; provided that the finger 10 does not remain in contact with this tactile key ««5» beyond the minimum contact duration. It is also conceivable that, once the locating relief 25 has been located, the visually impaired person lifts his/her finger 10 (to avoid lingering on the tactile key «5»), and places it back in the same location to resume dragging to the target tactile key 21.

Once the target tactile key 21 is reached, the finger 10 remains in contact with the target tactile key 21 for longer than the minimum contact time in order to select the character associated with this target tactile key 21.

The entry system 1 may also include at least one feedback transmitter connected to the processing unit 3, such as for example a vibratory feedback transmitter and/or an audible feedback transmitter. In the example of FIG. 3, the vibratory feedback transmitter corresponds to the vibratory alert transmitter 7, and the audible feedback transmitter corresponds to the audible alert transmitter 8; such that the processing unit 3 is configured to drive this vibratory feedback transmitter 7 and/or this audible feedback transmitter 8 in order to produce a feedback signal, which is audible or vibratory, when the processing unit 3 selects a character in the secondary mode S.

Thus, in the example where the additional validation condition corresponds to a double contact on the same tactile key 21, the visually impaired person is directly informed by means of the feedback signal that his/her second tactile contact on the same tactile key 21 has indeed resulted in the selection of the character associated with this tactile key 21; and he/she can then calmly initiate dragging to go and find another tactile key 21.

In the example where the additional validation condition corresponds to a long contact on the tactile key 21, the visually impaired person is directly informed by the feedback signal that his/her tactile contact has lasted long enough (beyond the minimum contact duration) on the tactile key 21 and has therefore resulted in the selection of the character associated with this tactile key 21; and he/she can then calmly initiate a drag to find another tactile key 21.

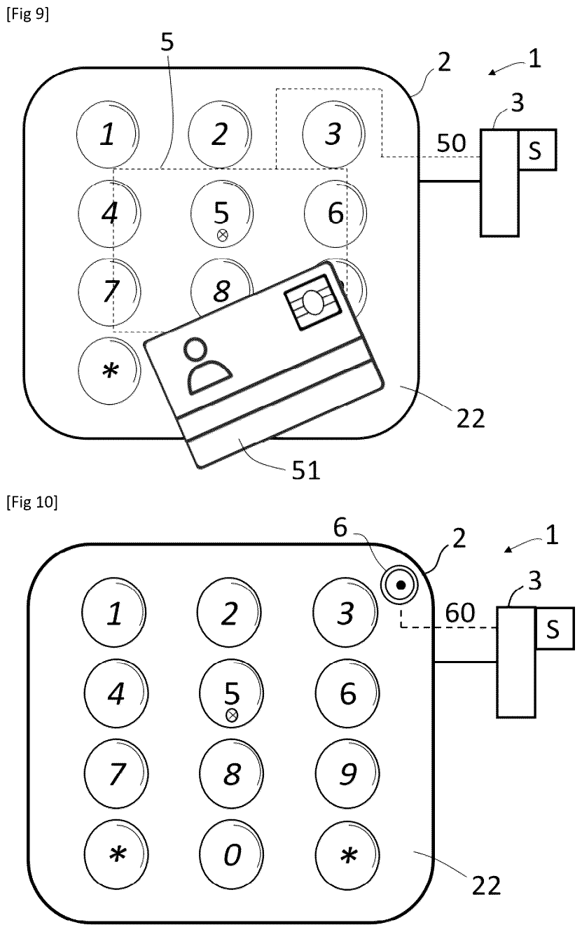

With reference to FIG. 9, in an alternative embodiment not covered by the claims, the at least one lateral approach sensor 4, 6 is replaced by a radio identification sensor 5 which is positioned on the tactile keyboard 2 (on one of its sides, or behind, or on the facade). The radio identification sensor 5 is for example provided with an antenna positioned at the rear of the front face 22, to detect the approach action in the form of an approach (within the range of the antenna) of a radio identification badge 51 containing (or registering) switching information. The radio identification badge 51 can be a card, a token, or be integrated into a mobile terminal such as a telephone. If the radio identification sensor 5 detects an approach of a radio identification badge 51, it generates an approach signal 50 which it transmits to the processing unit 3. Upon receipt of the approach signal 50, the processing unit switches the entry system 1 from the primary mode P to the secondary mode S.

In other variant, it is possible for the radio identification sensor 5 to be combined with the lateral approach sensor(s) 4, 6 described previously.

In different embodiments, the radio identification sensor 5 can operate in a radio identification technology in BlueTooth®, LoRa®, WiFi®, UWB, NFC, or other wireless technologies.

1. A secure access control reader comprising an entry system for entering a code comprising a sequence of characters, the entry system comprising:
a tactile keyboard provided with discrete tactile keys assigned to respective characters including at least numbers, each tactile key comprising a tactile detection surface and the tactile detection surface of at least one of the tactile keys is provided with a locating relief, the tactile keyboard being configured to generate key signals in response to tactile contacts exerted by a finger on the tactile detection surfaces of the tactile keys, each of the key signals being associated with the tactile key on which the tactile contact is exerted; and
a processing unit connected to the tactile keyboard to acquire the key signals generated by the tactile keyboard, and configured to analyze the key signals to select characters according to the key signals;
wherein the processing unit is configured to operate in two distinct modes which are:
a primary mode, suitable for sighted people, in which the processing unit is configured to select each of the characters by operating as follows: acquisition of a key signal followed by automatic assignment of the character which is assigned to the tactile key associated with said key signal, so that a character is automatically selected by a tactile contact of a finger on the tactile key assigned to the character; and
a secondary mode suitable for the visually impaired people and in which the processing unit is configured to select each of the characters as follows: acquisition of a key signal followed by a verification of an additional validation condition by analysis of the key signals, and allocation of the character which is assigned to the tactile key associated with said key signal only if the additional validation condition is met, so that a character is selected by a tactile contact of a finger on the tactile key assigned to the character followed by compliance with the associated additional validation condition;
wherein the secure access control reader comprises at least one lateral approach sensor shaped to detect an approach action performed by a user in the form of an approach or a contact of a hand of the user on at least one side of the tactile keyboard, and in response to deliver an approach signal, the at least one lateral approach sensor being distinct from the tactile keys of the tactile keyboard,
and wherein the processing unit is connected to the at least one lateral approach sensor and is configured to switch from the primary mode to the secondary mode upon receipt of the approach signal from the at least one lateral approach sensor.

2. The secure access control reader according to claim 1, wherein the processing unit is configured to be in the primary mode by default, in the absence of reception of the approach signal from the at least one lateral approach sensor.

3. The secure access control reader according to claim 1, wherein the processing unit, when in secondary mode, is configured to automatically switch from the secondary mode to the primary mode once the characters forming the code have been entered.

4. The secure access control reader according to claim 1, wherein the processing unit, when in secondary mode, is configured to automatically switch from the secondary mode to the primary mode if no key signal is generated by the tactile keyboard after a predefined period of time.

5. The secure access control reader according to claim 1, wherein the at least one lateral approach sensor comprises at least one side sensor which is positioned on the at least one side of the tactile keyboard.

6. The secure access control reader according to claim 5, wherein the at least one side sensor is selected from a capacitive sensor, an inductive sensor, a radar sensor, an ultrasonic sensor, an accelerometer, a camera and a mechanical sensor.

7. The secure access control reader according to claim 5, wherein the at least one side sensor comprises several side sensors arranged on several sides of the tactile keyboard, or a peripheral sensor extending over several sides of the tactile keyboard.

8. The secure access control reader according to claim 1, wherein the at least one lateral approach sensor comprises at least one facade sensor which is positioned on a front face of the tactile keyboard on which the tactile keys are arranged, the facade sensor having a detection field for detecting the approach or contact of the user's hand on the at least one side of the tactile keyboard.

9. The secure access control reader according to claim 8, wherein the at least one facade sensor is selected from a radar sensor, an ultrasonic sensor and a camera.

10. The secure access control reader according to claim 1, wherein the processing unit is configured so that, in the secondary mode, following the acquisition of a key signal, called the first key signal, associated with a tactile key assigned to a character, the additional validation condition comprises the acquisition of a second key signal associated with the same tactile key after a period without acquisition of a key signal between the acquisitions of the first key signal and the second key signal, so that a character is selected by a first tactile contact of a finger on the tactile key assigned to the character, followed by a removal of the finger, then followed by a second tactile contact of the finger on the same tactile key assigned to the character.

11. The secure access control reader according to claim 10, wherein the processing unit is configured so that, in the secondary mode, the additional validation condition also comprises a comparison between a maximum time threshold and the period between the acquisitions of the first key signal and the second key signal, so that a character is selected by the first tactile contact of the finger on the tactile key assigned to the character, followed by a removal of the finger then followed by the second tactile contact of the finger on the same tactile key assigned to the character, within a time less than the maximum time threshold between the first tactile contact and the second tactile contact.

12. The secure access control reader according to claim 1, wherein the processing unit is configured such that, in the secondary mode, the additional validation condition comprises a minimum contact duration for the key signal, such that a character is selected by a tactile contact of a finger on the tactile key assigned to the character under the condition that this tactile contact lasts at least the minimum contact duration.

13. The secure access control reader according to claim 1, wherein the processing unit is connected to at least one alert transmitter, which is audible or vibratory, and the processing unit is configured to drive the at least one alert transmitter in order to produce an alert signal, which is audible or vibratory, when the processing unit switches from the primary mode to the secondary mode.

14. The secure access control reader according to claim 1, wherein the processing unit is connected to at least one feedback transmitter, which is audible or vibratory, and the processing unit is configured to, at least in the secondary mode, drive the at least one feedback transmitter in order to produce an audible or vibratory feedback signal, when the processing unit selects a character.

15. An entry method for entering a code comprising a sequence of characters, the entry method being carried out on an entry system of a secure access control reader in accordance with claim 1, and comprising:
generating key signals in response to tactile contacts exerted by a finger on the tactile detection surfaces of the tactile keys, each of the key signals being associated with the tactile key on which the tactile contact is exerted;
acquiring by the processing unit the key signals generated by the tactile keyboard;
analyzing by the processing unit the key signals to select characters according to the key signals;
the entry method comprising a primary mode, suitable for the sighted people, in which the processing unit carries out the following steps to select each of the characters: acquisition of a key signal followed by an automatic allocation of the character which is assigned to the tactile key associated with the key signal, so that a character is automatically selected by a tactile contact of a finger on the tactile key assigned to the character;
the entry method comprising a secondary mode, suitable for the visually impaired people, in which the processing unit carries out the following steps to select each of the characters: acquisition of a key signal followed by a verification of an additional validation condition by analysis of the key signals, and allocation of the character which is assigned to the tactile key associated with the key signal only if the additional validation condition is met, so that a character is selected by a tactile contact of a finger on the tactile key assigned to the character followed by compliance with the associated additional validation condition;
the entry method comprising a step of switching from the primary mode to the secondary mode upon receipt of at least one approach signal from the at least one lateral approach sensor configured to detect an approach action performed by a user in the form of an approach or contact of a hand of the user on at least one side of the tactile keyboard, the at least one lateral approach sensor being distinct from the tactile keys of the tactile keyboard.
